(19) United States
(12) Patent Application Publication
(10) Pub. No.: US 2008/0019351 A1
(43) Pub. Date: Jan. 24, 2008

(54) Method And System For Affinity Management

(76) Inventors: Andrew A. Piper, Hampshire (GB); Malcolm M. Warwick, Surrey (GB); James R.H. Whyte, Berks (GB)

Correspondence Address: HOFFMAN, WARNICK & D'ALESSANDRO LLC, 75 STATE ST, 14 FL, ALBANY, NY, 12207, US

(21) Appl. No.: 10/598,791

(22) PCT Filed: Mar. 1, 2005
(86) PCT No.: PCT/EP05/50896

§ 371 Date: May 10, 2007

(30) Foreign Application Priority Data
Mar. 12, 2004 (GB) 0405595.0

(51) Int. Cl. G06F 9/50

(52) U.S. Cl. 370/352

(57) ABSTRACT

A method and system for affinity management in a distributed computer system are provided in which a plurality of addressing entities (311-315) need to be balanced across a plurality of service providers (301-304) whilst maintaining group affinities within the addressing entities. An identifier is provided for each of a plurality of addressing entities, wherein the identifier for each member of a group of addressing entities with an affinity is the same group identifier. A list is provided of service providers which are available to be addressed by an addressing entity to provide an instance of a service. The distribution of addressing entities to service providers is managed by an algorithm. The algorithm includes: applying (205) a hash function to the identifier of an addressing entity to obtain a standard integer; dividing (206) the standard integer by the number of service providers and obtaining the modulus; and selecting (207) a service provider by reference to the modulus. The addressing entity is sent to the instance (306) of the service provided by the selected service provider.

### TECHNICAL FIELD

This invention relates to the field of affinity management. In particular, the invention relates to affinity management in distributed computer systems including messaging systems.

### BACKGROUND ART

Affinity management is required in situations in which a plurality of entities wish to be handled in a similar manner. An example of such affinity can be provided in WebSphere MQ (WebSphere and MQ are trade marks of International Business Machines Corporation) messaging environments in distributed computer systems. Groups of messages can be sent where no member of the group is delivered until all the members have arrived. However, if each member of the group is delivered to a different queue manager, since the queue manager will not deliver until it sees all the members of the group, the result is that no group member is ever delivered. In this case the members of the group need to be treated with affinity to ensure that they are all sent to the same queue manager.

Another example of an affinity requirement is if there are two applications which rely on a series of messages flowing between them in the form of questions and answers. It may be important that all the answers are sent back to the same queue manager. It is important that the workload management routine does not send the messages to any queue manager that just happens to host a copy of the correct queue. Similarly, there may be applications that require messages to be processed in sequence, for example, a file transfer application or data base replication application that sends batches of messages that must be retrieved in sequence.

In clustered queue managers, a message may be routed to any queue manager that hosts an instance of the appropriate queue. Applications must be examined to see whether there are any that have message affinities such as a requirement for an exchange of related messages. The logic of applications with message affinities may be upset if messages are routed to different queue managers.

Affinity management in messaging systems can be handled by changing the way that the application opens a queue (for example, the BIND_ON_OPEN option on the MQOPEN call). However, this has the disadvantage of assuming that the application understands the issue of message affinity.

An embodiment of this invention is described in the context of WebSphere MQ messaging systems. In particular, in the environment of clustered queue managers. However, the invention is also applicable to a wide range of other distributed computing systems such as Web Services in which a number of related client applications wish to use the same instance of a web service. Another example is WebSphere Edge Server systems.

This invention is applicable in any situation in which affinity must be kept by a group of addressing entities such that each member of the group is directed to the same instance of a service. In the environment of WebSphere MQ, groups of messages can maintain affinity and all be sent to the same queue manager.

A history of the destination of transactions by addressing entities can be kept ensuring that if there is an affinity between addressing entities then the same destination can be selected. However, in high volume transaction systems, it is not always practical or efficient to keep such a history indicating where every transaction has been sent.

### DISCLOSURE OF INVENTION

According to a first aspect of the present invention there is provided a method for affinity management in a distributed computer system, the method comprising: providing an identifier for each of a plurality of addressing entities, wherein the identifier for each member of a group of addressing entities with an affinity is the same group identifier; determining the number of service providers which are available to be addressed by an addressing entity to provide an instance of a service; managing the distribution of addressing entities to service providers by the following method: applying a hash function to the identifier of an addressing entity to obtain a standard integer; dividing the standard integer by the number of service providers and obtaining the modulus; selecting a service provider by reference to the modulus; sending the addressing entity to the instance of the service provided by the selected service provider.

The step of determining the number of service providers may be carried out periodically and the number of service providers is constant within a period. Even if service providers are dynamic and join or leave during a period, the number of service providers is kept constant.

The method may include providing an index of the available service providers referenced by modulus values. For example, for six available service providers, the modulus values will be 0 to 5 and each modulus value can provide an index for one of the service providers.

If a selected service provider is unavailable, the addressing entity may be sent to the next service provider in a predetermined order. If a service provider fails, a process may be activated to retrieve previously delivered addressing entities. If a service provider fails, it may be reinstated after ensuring that there are no addressing entities with a group affinity in alternative service providers. Also, if a service provider fails, addressing entities sent to the service provider may be re-distributed.

In one embodiment, the distributed computing system may be a messaging system in which the addressing entities are messages and the service providers are clustered queue managers hosting instances of one or more cluster queues. The group identifier may be in the form of a Universally Unique Identifier (UUID).

In an alternative embodiment, the addressing entities may be client applications and the service providers may be Web Services hosting instances of a service.

According to a second aspect of the present invention there is provided a system for affinity management in a distributed computer system, the system comprising: a plurality of addressing entities each with an identifier, wherein the identifier for each member of a group of addressing entities with an affinity is the same group identifier; a list of a plurality of service providers which are available to be addressed by an addressing entity to provide an instance of a service; means for managing the distribution of addressing entities to service providers by using an algorithm with the following steps: applying a hash function to the identifier of an addressing entity to obtain a standard integer; dividing the standard integer by the number of service providers in the list and obtaining the modulus; and selecting a service provider by reference to the modulus; and means for sending the addressing entity to the instance of the service provided by the selected service provider.

The list of service providers may be updated periodically and the number of service providers on the list is constant within a period. A mechanism may be provided to inform a workload manager of the service providers given in the list. The system may include an index of service providers in the list referenced by modulus values.

If a selected service provider is unavailable, a workload manager may send the addressing entity to the next service provider in a predetermined order. If a service provider fails, means may be provided to retrieve previously delivered addressing entities. If a service provider fails, means may be provided to ensure that there are no addressing entities with a group affinity in alternative service providers before the failed service provider is reinstated. If a service provider fails, means may be provided to re-distribute addressing entities sent to the service provider.

In one embodiment, the distributed computing system may be a messaging system in which the addressing entities are messages and the service providers are clustered queue managers hosting instances of one or more cluster queues. The group identifier may be in the form of a Universally Unique Identifier (UUID).

In an alternative embodiment, the addressing entities may be client applications and the service providers may be Web Services hosting instances of a service.

According to a third aspect of the present invention there is provided a computer program product stored on a computer readable storage medium comprising computer readable program code means for performing the steps of: providing an identifier for each of a plurality of addressing entities, wherein the identifier for each member of a group of addressing entities with an affinity is the same group identifier; determining the number of service providers which are available to be addressed by an addressing entity to provide an instance of a service; managing the distribution of addressing entities to service providers by the following method: applying a hash function to the identifier of an addressing entity to obtain a standard integer; dividing the standard integer by the number of service providers and obtaining the modulus; selecting a service provider by reference to the modulus; sending the addressing entity to the instance of the service provided by the selected service provider.

### BRIEF DESCRIPTION OF THE DRAWINGS

Embodiments of the present invention will now be described, by way of examples only, with reference to the accompanying drawings in which:

FIG. 1 is a block diagram of a distributed computing system in accordance with the present invention;

FIG. 2 is a flow diagram of a method in accordance with the present invention; and

FIG. 3 is a block diagram of a messaging system in accordance with an embodiment of the present invention with clustered queue managers.

### MODE FOR THE INVENTION

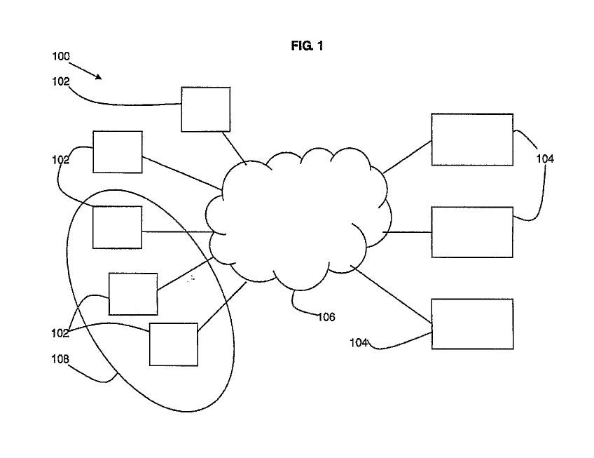

FIG. 1 shows a schematic diagram of a distributed computing system 100. This system 100 is used to illustrate in general terms an arrangement in which affinity management is required which can be provided by the described affinity management method. This can be applied to a wide range of different architectures. One embodiment in the form of WebSphere MQ messaging system is described.

A plurality of addressing entities 102 in the distributed computing system 100 can address more than one service provider 104 which provide the same service. Communication in the system 100 is via one or more networks 106 providing a communication infrastructure.

The term addressing entity is used as a general term including any means that addresses a service provider 104. For example, an addressing entity may be a client application or it may be a message in a messaging system.

A plurality of addressing entities 102 can be related in some way to form a group 108, the members of which have an affinity. Members of a group 108 must maintain their affinity by addressing the same instance of a service from available service providers 104.

The term service provider 104 is also used in a general sense. The plurality of service providers 104 provide instances of the same service to the addressing entities 102 such that any one of the plurality of service providers 104 may equally be chosen by an addressing entity 102. In the embodiment of the messaging system described below, the service providers 104 are queue managers and a plurality of queue managers may host an instance of a queue to which messages are addressed. In a Web Services environment, the plurality of service providers 104 may each host an instance of a service to be addressed by client applications.

In the described method of affinity management, it is first determined which service providers are participating in the group distribution at a particular time. That is, the service providers which may equally be chosen by addressing entities to carry out a service. A list of the participating service providers is static for a time period until such a time as the list is revised. The time period can be a regularly updated period or it can be an irregular period, for example, determined by the number of service providers on the list that continue to be available.

If a service provider becomes available after the list has been determined, the service provider will not be added to the list until the list is revised. Similarly, if a service provider is given in the list but ceases to be available, the service provider remains on the list until the list is revised. A failover mechanism which is described below is used in such instances where an addressing entity is sent to a service provider which is no longer available.

From the list of service providers, the number of service providers on the list for the time period is counted. This number is used in a choosing or balancing algorithm to choose the service provider for each addressing entity during the time period. An index is established of the service providers referenced by the numbers 0 to n, where n is the number of service providers on the list.

The choosing algorithm is used when an addressing entity wishes to address a service provider. An addressing entity has an identifier which may be a name, an ID reference, a Universally Unique Identifier (UUID), etc. Members of a group of addressing entities that need to keep an affinity have the same group identifier. The identifier is hashed by means of any suitable hash operation, to obtain a standard integer.

The standard integer is divided by the number of service providers, n, counted from the list for the current time period and the modulus is obtained. The modulus is used to reference the index to determine which service provider the addressing entity should address.

As the addressing entities which are members of an affinity group have the same identifier, for example, a group ID, each member of the group will be sent to the same service provider. If the addressing entities have different identifiers, they will be sent to any one of the service providers depending on the outcome of the choosing algorithm which results in a random distribution of the addressing entities across the participating service providers in the list.

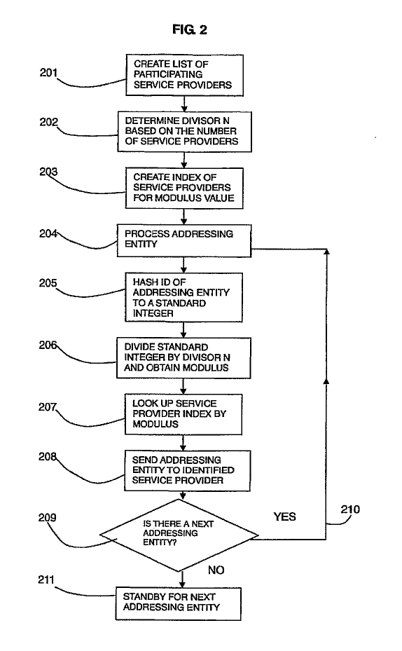

FIG. 2 is a flow diagram illustrating the above method. At the first step 201, a list of participating service providers is created. A divisor based on the number of service providers, n, is determined 202. An index of the service providers for each modulus value is created 203.

An addressing entity is processed 204. The hash of the identifier of the addressing entity is carried out to obtain a standard integer 205. The standard integer is divided by the divisor, n, to obtain a modulus 206. The index of service providers is looked up for the modulus value obtained 207. The addressing entity is sent to the service provider identified in the index for the modulus 208.

It is then determined if there is another addressing entity waiting to be processed 209, if there is, a loop 210 in the method is carried out for the next addressing entity. If there are no more addressing entities, the process is put on standby for the next addressing entity to be processed 211.

In a messaging environment in which the addressing entities to be processed are messages, step 204 is triggered by the arrival of a message and steps 205 to 208 are carried out for the message. Therefore, the loop 210 is not required.

This method enables a group of addressing entities to maintain an affinity by members of an affinity group having the same identifier and therefore being sent to the same service provider.

A failover mechanism is provided to handle instances in which an addressing entity is sent to a service provider which is not available. If a service provider is unavailable, the addressing entity is sent to the next service provider in a failover list. In this way, all addressing entities which are sent to an unavailable service provider are sent to the same fallback service provider thereby maintaining the affinity of a group of addressing entities.

If a service provider fails, it may need to send its addressing entities back to be re-processed and redirected to service providers accounting for affinities whilst load balancing the addressing entities with no affinities across available resources. A process to retrieve all previously directed addressing entities is required.

An embodiment is described in the environment of WebSphere MQ messaging systems. Applications running on different computers or nodes within a network are able to communicate using messages and queuing. Communication by messaging and queuing enables applications to communicate across a network without having a private, dedicated, logical connection to link them. Communication is by putting messages on message queues and taking messages from message queues.

Each node in a network has a queue manager. The queue managers interface to applications through a message queue interface that is invoked by the applications. The message queue interface supports many different operating system platforms.

In distributed queuing systems, the queue managers are independent and communicate using distributed queuing. One queue manager sending a message to another queue manager must have defined a transmission queue, a channel to the remote queue manager and a remote-queue definition for every queue to which it wants to send messages.

When queue managers are grouped in a cluster, the queue managers can make the queues that they host available to every other queue manager in the cluster. Any queue manager can send a message to any other queue manager in the same cluster without the need for explicit channel definitions, remote-queue definitions, or transmission queues for each destination. Every queue manager in a cluster has a single transmission queue from which it can transmit messages to any other queue manager in the cluster. Each queue manager in a cluster needs to define only one cluster-receiver channel on which to receive messages, and one cluster-sender channel with which it introduces itself and learns about the cluster.

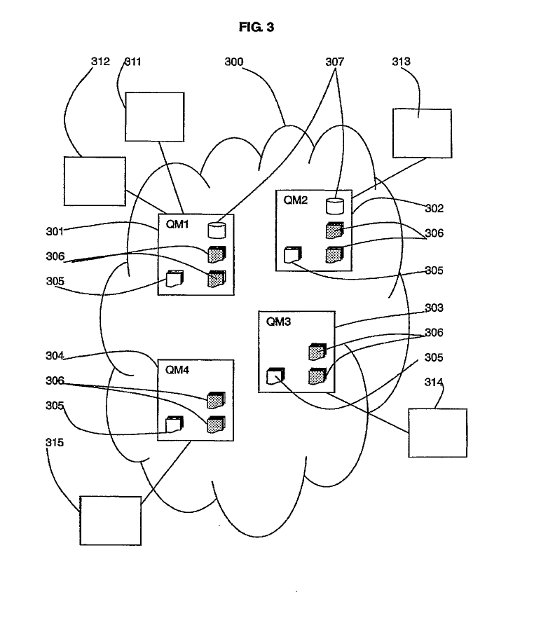

FIG. 3 shows a cluster of queue mangers 300 in a messaging system. Four queue managers QM1 301, QM2 302, QM3 303 and QM4 304 are shown. Each of the queue managers serves one or more applications 311, 312, 313, 314, 315.

Each queue manager can have local queues 305 which are only accessible to the applications served by that queue manager. Each queue manger in the cluster can also have cluster queues 306. The cluster queues 306 are accessible to any other queue manager in the cluster. One or more of the queue managers can also host repositories 307 of information about the queue managers in a cluster.

An application 311 uses an MQPUT call to put a message on a cluster queue 306 at any queue manager 301, 302, 303, 304. An application 311 uses the MQGET call to retrieve messages from a cluster queue 306 on the local queue manager 301.

Messages sent to a cluster 300 are spread around the instances of a cluster queue 306 in available queue managers 301, 302, 303, 304 by a workload manager in a distributing queue manager which balances the workload.

WebSphere MQ messaging systems provide the ability to send groups of messages where no member of the group is delivered until all have arrived. This is an example of a group which requires all the messages to be sent to the same queue manager in a cluster. If the messages in the group are sent to different queue managers, the messages will not deliver as any one queue manager does not see all the messages having arrived. There is a need to assure that messages belonging to a given group have affinity to the same queue manager within the cluster. However, non-grouped messages must not be affected so that there is still a balance of the workload across the queue managers in a cluster.

Group members are identified as such by a GroupID manifested as a 24 byte Universally Unique Identifier (UUID). Each member of the group also has a sequence number and the final member of the group identifies itself as such.

In the described method, a workload manager at a distributing queue manager in a cluster carries out a balancing algorithm to determine which queue manager's cluster queue a message is sent to. The balancing algorithm, maintains group member affinities by ensuring that the members of a group are sent to the same queue manager in the cluster.

The balancing algorithm carries out a hash function on the GroupID to obtain a standard integer. The modulus of the standard integer is obtained by dividing by the number of queue managers to determine the index of the target queue manager.

A list in the form of a configuration file or other mechanism is used to inform the distributing queue manager of the cluster queues taking part in the group distribution. This list determines the divisor to obtain a modulus which is used in the balancing algorithm. The divisor is the number of queue managers and hence the number of instances of a cluster queue to which a message may be sent. The list does not change regardless of queues entering or leaving a cluster allowing the balancing algorithm to consistently address the correct queue.

This allows the distributing queue manager to send all members of the same group of messages to the same queue manager without holding state or incurring a large overhead for checking histories, etc.

A cluster of queue managers is dynamic such that queue managers may join or leave at any time. If the divisor were to be based on a current number of queue managers the balancing algorithm would be error prone. Thus, the balancing algorithm is given a list of queue managers to choose from which is static and allows the balancing algorithm to be consistent in choice of queue manager.

In addition, queue managers fall in a domino fashion. For example, if there are four queue managers in the cluster as shown in FIG. 3, the queue managers have a predetermined order: QM1, QM2, QM3, QM4. If one queue manager, QM1, fails, its messages are sent back to the workload manager. If a queue manager, QM1, is chosen by the balancing algorithm and is unavailable, then the next in line is chosen, i.e. QM2.

This domino failover technique is enabled in conjunction with a process to retrieve all previously delivered group members. The re-establishment of the recovered queue manager needs to occur with similar controls.

Once a queue manager is noted as failed it cannot be reinstated without ensuring that there are not any messages belonging to a group waiting in the alternative queue managers.

Also, if a queue manager is newly detected as failed, the messages must be stored for transmission in the normal WebSphere MQ system manner, until informed that the queue manager has been closed and that the already delivered messages will be re-distributed.

In this way, the workload of a failed queue manager can be recovered whilst accounting for affinities and balancing the messages with no affinities across the available resource.

### EXAMPLE

In the example shown in FIG. 3, there are four available queue managers. A list of queue managers and hence available instances of a cluster queue is compiled as an index with each queue manager having an index number:

QM1=0,

QM2=1,

QM3=2,

QM4=3.

As there are four queue mangers in the list, a divisor for use in the balancing algorithm is 4. This remains constant until the list is revised and a new divisor is determined.

In this example, there are some groups of messages which have group identifiers. The group identifiers have been chosen as proper names for the purposes of illustration. In practice a group identifier may be, for example, a GroupID in the form of a 24 byte UUID.

The hash function in this example allocates a number in sequence to the letters of the alphabet and adds the numbers together to obtain a standard integer.

The following table shows the operation of the hash function on the names of the groups.

| | STANDARD | DIVIDED BY | INDEX BASED |
|---|---|---|---|
| GROUP NAME | INTEGER | DIVISOR | ON MODULUS |
| HAMPSHIRE | 97 | 24 + 1 | 1 |
| WILTSHIRE | 123 | 30 + 3 | 3 |
| SUSSEX | 107 | 26 + 3 | 3 |
| HERTFORDSHIRE | 153 | 38 + 1 | 1 |
| DORSET | 81 | 20 + 1 | 1 |
| DEVON | 60 | 15 + 0 | 0 |
| CORNWALL | 98 | 24 + 2 | 2 |

The index number obtained by the balancing algorithm for members of a group with an identifier of “HAMPSHIRE” is “1”. Therefore, the members of the group are sent to QM2. The following table shows the destination of the members of each group.

| QUEUE MANAGER | INDEX | GROUPS |
|---|---|---|
| QM1 | 0 | DEVON |
| QM2 | 1 | HAMPSHIRE |
| | | HERTFORDSHIRE |
| | | DORSET |
| QM3 | 2 | CORNWALL |
| QM4 | 3 | WILTSHIRE |
| | | SUSSEX |

In this way, members of groups with affinities are sent to the same queue manager whilst balancing the workload across the queue managers.

The present invention is typically implemented as a computer program product, comprising a set of program instructions for controlling a computer or similar device. These instructions can be supplied preloaded into a system or recorded on a storage medium such as a CD-ROM, or made available for down loading over a network such as the Internet or a mobile telephone network.

Improvements and modifications can be made to the foregoing without departing from the scope of the present invention.

1-18. (canceled)

19. A method for affinity management in a distributed computer system, comprising:
providing an identifier for each of a plurality of addressing entities, wherein the identifier for each member of a group of the addressing entities with an affinity is the same group identifier;
determining a number of service providers which are available to be addressed by an addressing entity to provide an instance of a service; and
managing a distribution of addressing entities to service providers by:
applying a hash function to the identifier of an addressing entity to obtain a standard integer;
dividing the standard integer by the number of service providers and obtaining a modulus;
selecting a service provider by reference to the modulus; and
sending the addressing entity to the instance of the service provided by the selected service provider.

20. A method as claimed in claim 19, wherein the step of determining the number of service providers is carried out periodically and the number of service providers is constant within a period.

21. A method as claimed in claim 19, wherein the method includes providing an index of the available service providers referenced by modulus values.

22. A method as claimed in claim 19, wherein if a selected service provider is unavailable, the addressing entity is sent to the next service provider in a predetermined order.

23. A method as claimed in claim 19, wherein if a service provider fails, a process is activated to retrieve previously delivered addressing entities.

24. A method as claimed in claim 19, wherein if a service provider fails, that service provider can be reinstated after ensuring that there are no addressing entities with a group affinity in alternative service providers.

25. A method as claimed in claim 19, wherein if a service provider fails, addressing entities sent to that service provider are re-distributed.

26. A method as claimed in claim 19, wherein the distributed computing system is a messaging system, the addressing entities are messages and the service providers are clustered queue managers hosting instances of one or more cluster queues.

27. A method as claimed in claim 26, wherein the group identifier is in the form of a Universally Unique Identifier (UUID).

28. A method as claimed in claim 19, wherein the addressing entities are client applications and the service providers are Web Services hosting instances of a service.

29. A system for affinity management in a distributed computer system, the system comprising:
a plurality of addressing entities each with an identifier, wherein the identifier for each member of a group of addressing entities with an affinity is the same group identifier;
a list of a plurality of service providers which are available to be addressed by an addressing entity to provide an instance of a service;
means for managing a distribution of addressing entities to service providers by using an algorithm with the following steps:
applying a hash function to the identifier of an addressing entity to obtain a standard integer;
dividing the standard integer by the number of service providers in the list and obtaining a modulus; and
selecting a service provider by reference to the modulus; and
means for sending the addressing entity to the instance of the service provided by the selected service provider.

30. A system as claimed in claim 29, wherein the list of service providers is updated periodically and the number of service providers on the list is constant within a period.

31. A system as claimed in claim 29, wherein a mechanism is provided to inform a workload manager of the service providers given in the list.

32. A system as claimed in claim 29, wherein the system includes an index of service providers in the list referenced by modulus values.

33. A system as claimed in claim 29, wherein if a selected service provider is unavailable, a workload manager sends the addressing entity to the next service provider in a predetermined order.

34. A system as claimed in claim 29, wherein if a service provider fails, means are provided to retrieve previously delivered addressing entities.

35. A system as claimed in claim 29, wherein if a service provider fails, means are provided to assure that there are no addressing entities with a group affinity in alternative service providers before the failed service provider is reinstated.

36. A system as claimed in claim 29, wherein if a service provider fails, means are provided to re-distribute addressing entities sent to that service provider.

37. A system as claimed in claim 29, wherein the distributed computing system is a messaging system, the addressing entities are messages and the service providers are clustered queue managers hosting instances of one or more cluster queues.

38. A system as claimed in claim 37, wherein the group identifier is in the form of a Universally Unique Identifier (UUID).

39. A system as claimed in claim 29, wherein the addressing entities are client applications and the service providers are Web Services hosting instances of a service.

40. A computer program product stored on a computer readable storage medium comprising computer readable program code means for performing the steps of:
providing an identifier for each of a plurality of addressing entities, wherein the identifier for each member of a group of addressing entities with an affinity is the same group identifier;
determining the number of service providers which are available to be addressed by an addressing entity to provide an instance of a service;
managing the distribution of addressing entities to service providers by:
applying a hash function to the identifier of an addressing entity to obtain a standard integer;
dividing the standard integer by the number of service providers and obtaining a modulus;
selecting a service provider by reference to the modulus; and
sending the addressing entity to the instance of the service provided by the selected service provider.
